(19) United States
(12) Patent Application Publication
(10) Pub. No.: US 2005/0043886 A1
(43) Pub. Date: Feb. 24, 2005

(54) Delivery system and method for low visibilty conditions

(76) Inventors: John Stevens, Ontario (CA); Paul Waterhouse, Ontario (CA); Mike Vandenberg, Ontario (CA)

Correspondence Address: MCGINN & GIBB, PLLC, 8321 OLD COURTHOUSE ROAD, SUITE 200, VIENNA, VA, 22182-3817, US

(21) Appl. No.: 10/479,869

(22) PCT Filed: Jun. 6, 2002
(86) PCT No.: PCT/US02/17812

(51) Int. Cl. G01C 21/26

(52) U.S. Cl. 701/213

(57) ABSTRACT

An inventive system for delivering a package (e.g., plurality of packages) includes a transport vehicle for transporting the package to a destination, the transport vehicle including a first transceiver and a computer system, and an electronic positioning system for navigating the transport vehicle to the destination under a low-visibility condition.

### BACKGROUND OF THE INVENTION

1. Field of the Invention

The present invention relates to a system and method for delivering packages, and in particular, to a system and method for delivering packages which uses a positioning system to facilitate delivery, for example, in low visibility conditions.

2. Description of the Related Art

In a conventional delivery system, packages are sorted at a distribution center according to a particular area or route corresponding to a particular driver or truck. The packages have been pre-sorted into the approximate hour of anticipated delivery, and then placed on the truck. The driver has a printed list of addresses and number of items for each address. The driver drives along the streets until he finds the address, parks the truck, and goes to the back of truck with the printed list. The driver then locates the package having the correct name and address, checks off a list taken to the door at the destination address and obtains a signature or some other indication that the package was delivered.

However, such conventional delivery schemes are severely affected by low visibility conditions such as nighttime conditions and adverse weather conditions such as fog, snow or a hard rain. In such conditions, delivery drivers relying solely on a hand held paper map or their memory of a certain street, apartment complex or office complex often have a hard time locating the correct destination addresses for the packages. As a result, deliveries are often delayed during such conditions.

### SUMMARY OF THE INVENTION

In view of the foregoing and other problems, disadvantages, and drawbacks of the conventional methods and structures, an object of the present invention is to provide a system and method for delivering packages under low-visibility conditions.

An inventive system for delivering a package (e.g., plurality of package) includes a transport vehicle for transporting the package to a destination, the transport vehicle including first transceiver and a computer system, an electronic positioning system for navigating the transport vehicle to the destination under a low-visibility condition. The inventive system may also include a drop-box having a second transceiver for wirelessly communicating with the first transceiver, and a signaling device (e.g., light-emitting device such as a light-emitting diode, or an audible device) for locating the drop-box under a low-visibility condition. The system may also include a detecting device (e.g., a photodiode) for detecting a low-visibility condition.

Further, the computer system may include a locator database for storing detailed location data for the drop-box. In addition, data from said electronic positioning system may be refined using such detailed location data.

In addition, during a low visibility condition, the first transciever may wirelessly communicate with the the second transceiver, causing the drop-box to activate the signaling device. In addition, the signaling device is activated when the transport vehicle is within a predetermined distance of the drop-box.

The inventive system may also include an electronic tag associated with the package. The electronic tag may include a signaling device which activates when the transport vehicle is within a predetermined distance of the destination, and a third transceiver, for wirelessly communicating with the first and second transceivers.

Further, a low-visibility condition may include a nighttime condition and/or an adverse weather condition. A low-visibility condition may also include a condition under which the drop-box is obscured (e.g., hidden) from a view of a person delivering the package.

Further, the signaling device may be manually activated using the computer system to regulate a signal transmitted from the first transceiver to the second transceiver. In addition, a magnitude of a signal emitted by the signaling device may be regulated by using the computer system to regulate a signal transmitted from the first transceiver to the second transceiver.

In another aspect, the inventive system for delivering packages may include a transport vehicle having a first transceiver and a computer system, an electronic tag associated with the packages and having a signaling device which activates when a package arrives at a destination and a second transceiver for wirelessly communicating with the transport vehicle, and an electronic positioning system for navigating the transport vehicle to the destination according to an optimum delivery route.

The electronic positioning system may include, for example, a satellite-based global positioning system (GPS) having at least one satellite for wirelessly transmitting signals, a ground based control station for uploading data to and receiving signals from the satellite, and a user receiver located on the transport vehicle, for receiving signals from the satellite. The electronic positioning system may also include a dead reckoning (DR) system which measures compass direction and a speed of the transport vehicle. The electronic positioning system may also include a solid state gyroscope.

Further, the global positioning system may be a differential global positioning system which further includes a reference station which compares predicted pseudoranges to actually measured pseudoranges, computes correction data for each satellite and broadcasts correction data over a separate data link to the user receiver. In this case, the user receiver applies the correction data to a pseudorange measurement to compute a position.

Further, the electronic positioning system could include a hybrid system including, for example, a global positioning system augmented by a dead reckoning (DR) system

In addition, the inventive system may include a base station comprising a third transceiver for wirelessly communicating with the transport vehicle and the electronic tag. The inventive system may also include a drop-box located at a package destination, having a fourth transceiver for wirelessly communicating with the transport vehicle, the electronic tag and the base station.

In the inventive system, the signaling device on the electronic tag may be activated when the package arrives at its destination. Further, the first and second transceivers wirelessly communicate with each other to minimize a delivery time.

The present invention also includes an inventive method for delivering a package (e.g., plurality of packages). The inventive method includes transporting the package to a destination using a transport vehicle, and navigating the transport vehicle to the destination under a low-visibility condition, using an electronic positioning system.

In another aspect, the inventive method may include associating the packages with electronic tags, inputting a destination address to a computer system to determine an optimum delivery route, placing the packages on a transport vehicle, and navigating the transport vehicle to a destination using an electronic positioning system. The inventive method may also include activating a signaling device on a particular electronic tag when the transport vehicle arrives at a destination of a package associated with that particular electronic tag.

The present invention also includes a programmable storage medium tangibly embodying a program of machine-readable instructions executable by a digital processing apparatus to perform the inventive method.

With its unique and novel aspects, the present invention provides a system and method for effectively and accurately delivering a package in a low-visibility condition.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 illustrates a system 100 for delivering packages in adverse conditions according to the present invention;

FIG. 2 illustrates a container 200 for holding a package to be delivered, according to the present invention;

FIG. 3 illustrates an electronic tag 210 used in the inventive system according to the present invention;

FIG. 4 illustrates the circuitry of the electronic tag 210 used in the inventive system according to the present invention;

FIG. 5 is a flow chart of communications in the inventive system according to the present invention;

FIG. 6 illustrates an electronic tag 210 temporarily affixed to a package as used in the inventive system according to the present invention; and

FIG. 7 is a flow chart illustrating the inventive method 700 for delivering packages in a low-visibility condition according to the present invention.

### DETAILED DESCRIPTION OF THE PREFERRED EMBODIMENTS

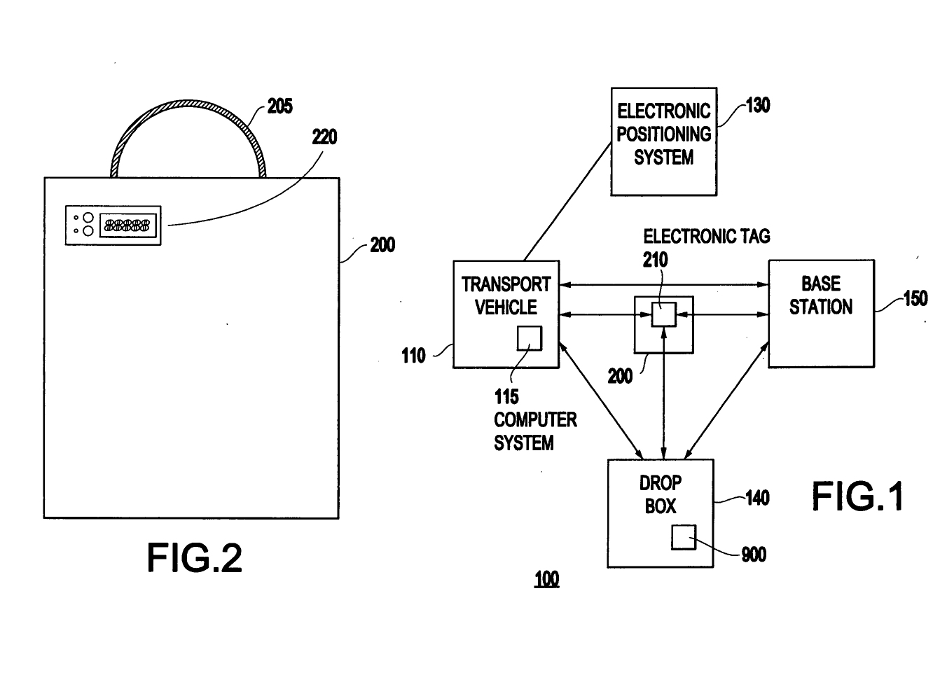

Referring now to the drawings, FIG. 1 illustrates an inventive system 100 for minimizing package delivery time according to the claimed invention.

Generally, the inventive system 100 includes a transport vehicle 110 having a first transceiver and a computer system 115, and an electronic tag 210 associated with at least one of the packages and having a signaling device which activates when a package arrives at destination and a second transceiver for wirelessly communicating with the transport vehicle 110. Further, the inventive system 100 also includes an electronic positioning system 130, for navigating the transport vehicle to the destination according to an optimum delivery route. In addition, the inventive system 100 may include a base station 150 having a transceiver and a drop box 140 which also has a transceiver and is located at the package destination for receiving the package.

It should be noted that the term “low-visibility” may refer to any condition under which the delivery person will find it difficult to locate the drop-box at the destination for the package. In other words, “low-visibility” does not just refer to environmental conditions, but may refer to any situation where the destination (e.g., drop-box) is obscured from the view of the delivery person. For instance, a low-visibility condition may exist when a drop-box is around a corner or under a fixture or even enclosed within a building, so that the drop-box is out of view of the delivery person.

Specifically, to help facility a delivery during a low-visibility condition, the drop box in the inventive system 100 may include a signaling device (e.g., a plurality of signaling devices) to aid the delivery person. The signaling device may include, for example, a light emitting device (e.g., a light-emitting diode) or an audible device (e.g., an electronic alarm or beeper).

For instance, when the transport vehicle is within a certain distance of the package destination (e.g., drop-box), the transciever on the transport vehicle may wirelessly communicate with the transceiver on the drop-box which causes the drop-box to activate the signaling device on the drop-box. This will help the delivery driver to easily locate the drop box, for example, in low-visibility conditions.

Alternatively, when the package is within a certain distance from the package destination, the transceiver associated with the package may wirelessly communicate with the transceiver on the drop-box, causing the drop-box transceiver to activate a signaling device on the drop-box.

Further, when the delivery person has located the drop-box, the delivery person may merely push a button on the electronic tag (e.g., module) associated with the package, which causes the transceiver in the electronic tag to wirelessly transmit a signal to the drop-box transceiver, causing the drop-box to deactivate the signaling device. Alternatively, the signaling device may be deactivated by pushing a button on the drop-box.

The system 100 may further include a detecting device 900 (e.g., a photodiode) for detecting a low-visibility condition. For example, the detecting device 900 may detect a nighttime condition or adverse weather condition based on the amount of light detected by the detecting device 900. Further, the detecting device 900 may be operatively coupled to the drop box (e.g., housed in a part of the drop box) so that the drop box is made to provide a brighter light or louder audible signal during a low-visibility condition. For example, if a low-visibility condition is detected, the drop box may cause more light emitting devices to be activated when the transport vehicle arrives at the location of the drop box, than under normal (e.g., good-visibility) conditions. Therefore, the drop box will be easier to locate by the delivery driver, for example, at night or in adverse weather.

Further, the signal (e.g., light or audible) emitted by the drop box may be caused to increase or decrease gradually depending on the visibility detected by the detecting device 900. In other words, the magnitude of the signal may vary infinitely based on the visibility detected by the detecting device 900.

Alternatively, the delivery person may be able to manually activate the signaling device on the drop-box, or to manually vary the magnitude of the signal emitted by the signaling device. This may be desirable, for instance, where the delivery person cannot find the drop-box because the drop-box is around a corner or in a building, and is therefore, hidden from the view of the delivery person.

For example, the computer system on the transport vehicle may include a device for regulating the signal transmitted by the transceiver on the transport vehicle to the drop-box transceiver. Further, the magnitude of the signal emitted by the drop-box may vary depending upon the signal transmitted by the transport vehicle transceiver. Therefore, the delivery person may used the computer system to activate and regulate the magnitude of the signal emitted by the drop-box.

For instance, the delivery person may use the electronic positioning system to determine a general location (e.g., address) of the package destination. However, the exact location of the drop-box at that location may be unknown to the delivery person. This may be the case, for instance, where the package destination is at a large business center, apartment complex, etc. For example, the drop-box may be enclosed at the destination within a building or other structure (e.g., for aesthetic purposes) so that the delivery person cannot locate the drop-box. In this case, the delivery person may manually activate the signaling device on the drop-box. Thus, if the drop-box is around a corner, the delivery person may use the light emitted from the signaling device on the drop-box to locate the drop box.

Moreover, using the computer system on the transport vehicle, the delivery person may cause only a first form of signal (e.g., light) to be emitted by the drop-box. However, if the delivery person still is not able to locate the drop-box, he may cause a second form of signal (e.g., audible). This feature may help to ensure that the delivery person can locate the drop-box under any condition.

In addition, the computer system on the transport vehicle may also include a locator database which contains more detailed information regarding the location of the drop-box at a package destination. For instance, the database may store text information, such as “the drop-box is located on the second floor of Building 1”. This information may be used to further refine the information provided to the delivery person by the electronic positioning system.

Alternatively, the database may include distances from a street or building associated with the destination, at which the drop-box may be located. More specifically, the database may be used to store distances or directions (e.g., north, south, etc.) defining the drop-box location relative to a street, intersection or other landmark identified by the electronic positioning system. In this case, the electronic positioning system receiver (e.g., GPS receiver) on the transport vehicle may interact with the computer system in order to display a more detailed location of the drop box.

For instance, the map displayed by the GPS may be modified by the computer system based on the data (e.g., directional data) stored in the locator database. For example, the data may be used to identify on a display screen, not merely a destination address, but where specifically at the address, the drop-box is located. For instance, the computer system may use the data from the locator database to generate an additional screen which identifies the destination generally, and also the exact drop-box location within the destination address. For example, this additional display screen may show the destination as a box, the orientation of the destination (e.g., north, south, east, west), a scaling feature (e.g., one inch=100 feet) and a locating dot within the box corresponding to the exact location of the drop-box.

In addition, when the delivery person inputs a destination address in the computer system on the transport vehicle, the computer system may automatically determine an optimum route to follow in order to make the delivery to the address. Further, the computer system may search (e.g., automatically search) the database for more detailed instructions on where specifically the drop-box is located at the destination address. This may also be performed concurrently with determining an optimum route in order to save time.

When data pertaining to a particular destination address is found in the database by the computer system, the computer system may cause the data to be displayed, for example, on a display device (e.g., video display device) for the delivery person. Further, the locator database may be updated by the delivery person by manually entering such information into the computer system using an input device (e.g. keyboard, mouse, etc.) attached to the computer system.

Alternatively, this information may be entered into a computer system at the base station and wirelessly communicated to the computer system on the transport vehicle for storage in the database. This may be useful, for example, when it is desired to simultaneously update the computer system databases on an entire fleet of transport vehicles.

Specifically, the electronic positioning system 130 in the inventive system may include, for example, a gyroscope, a satellite-based global positioning system (GPS), a dead reckoning (DR) system, or a hybrid system containing the features of such positioning devices. The electronic positioning system 130 may, for example, aid in the delivery of packages in low-visibility conditions such as nighttime conditions and adverse conditions such as adverse weather conditions.

For example, the electronic positioning system 130 may include a satellite-based global positioning system (GPS). The GPS system was developed by the U.S. Air Force to provide worldwide coverage, high accuracy three-dimensional position, velocity and time, and permitting completely passive (receive-only) operation. The GPS was developed for military use but has now found wide acceptance by civil users such as commercial and general aviation aircraft, commercial ships and pleasure boats and operators of surveying systems.

The GPS is a pseudoranging system in which several transmitter sources, whose positions are known to the user, transmit highly time synchronized signals on established system time epochs. With these time epochs known to the user, the user measures the time-of-arrival (TOA) of each signal with respect to its own clock, which normally has some time offset from system time. The resulting range measurement (by multiplying the speed of light) is called pseudorange (PR), since it differs from the true range, as a result of the user's time offset. From several successive or simultaneous such TOA measurements from four or more sources, the user then calculates the three-dimensional position coordinates and its own time offset from system time.

Thus, in the global positioning system of the inventive system 100, a user receiver located in the transport vehicle 110 determines at least four pseudoranges by time-of-arrival measurements with respect to its own clock time, and can also determine four pseudorange rates or delta pseudoranges via Doppler measurements with respect to its own clock frequency. From these measurements, the user receiver computes the three-dimensional position coordinates of the transport vehicle 110 and a clock time offset, as well as the three-dimensional velocity coordinates of the transport vehicle 110 and a clock frequency offset.

In addition, the global positioning system may be a differential global positioning system. In this case the global positioning system includes a reference station which compares predicted pseudoranges to actually measured pseudoranges, computes correction data for each satellite and broadcasts the correction data over a separate data link to the user receiver. The user receiver may then apply this correction data to a pseudorange measurement to compute a more accurate position.

Further, the electronic position system 130 may include a Dead Reckoning (DR) system. Dead reckoning combines the measured compass direction and the transport vehicle's logged speed (or distance traveled) to determine the transport vehicle's track from its starting point. The transport vehicle's speed may be measured, for example, using an electronic speed sensor that measures axle or drive shaft rotations. Its processed output signal gives measurements of speed and distance traveled.

In addition, the transport vehicle's direction may be measured using a gyroscope (e.g., a solid state gyroscope). A gyroscope's direction-keeping capability stems from its spinning top-like tendency to maintain initial upright direction despite gravity trying to make it fall. Further, the gyroscope may be, for example, a solid-state gyroscope.

Furthermore, to the electronic positioning system 130 may include a hybrid system in which one system is used to augment a main system. For example, the global positioning system may be augmented by an on-board navigation system on the transport vehicle 110. Such a navigation system may pair an electronic map stored on CD-ROM with in-vehicle sensors, giving a rough position, distance traveled, and turns taken by the transport vehicle 110. The navigation system matches the data to stored geographical street information and determines the transport vehicle's position. The navigation system may include a video display for displaying instructions and direct drivers to an individual street address.

In addition, the electronic positioning system 130 may include a hybrid global positioning and dead reckoning (GPS/DR) system. In this case, the dead reckoning system may be used to augment the global positioning system. Such a system 130 may be effective to maintain an effective and accurate operation of the system 130 from being affected by adverse conditions.

For example, such a system 130 may eliminate multipath (i.e., reflections of GPS signals from buildings) and shadowing (i.e., poor signal propagation in cities or under dense vegetation). Such a system 130 may also be used to prevent signal loss in tunnels, undercover car parks, and covered roadways, extended time to first fix (TTFF) in poor signal areas and dynamic limitations, such as maximum jerk (rate of change of acceleration).

For example, the hybrid GPS/IDR system may use the transport vehicle's speed sensor to measure speed and its reverse light to indicate when it moves backward. A miniature vibrating beam or tuning fork gyroscope measures the rate of turn. These gyroscopes may operate, for example, from a 5-volt DC supply and typically have an approximately 22 millivolts/degree/second sensitivity. Zero degrees per second (called the gyro bias voltage, or just bias) may be approximately 2.5 volts. To determine the vehicle's heading, the hybrid system 130 subtracts the gyro bias from the gyro output and integrates the result to yield the direction change relative to a known initial heading.

Through careful signal processing and sensor management, the electronic positioning system 130 can derive reliable measurements of vehicle heading and distance over ground. Using these measurements and standard navigation equations, the DR system calculates an inertial position solution. The GPS may then correct the inertial position and heading estimates as well as the gyro bias and speed sensor scale factor estimates to provide an accurate position of the transport vehicle.

Specifically, the GPS/DR system has an inertial subsystem which includes the gyro, vehicle speed sensor, the software managing them, and the navigation equations that transform the heading and distance over ground to a position solution. The solution must be expressed in the same coordinate system used by the GPS's user receiver (in most cases, geodetic coordinates referenced to the WU584 datum). The user receiver provides reference solutions for position, speed, and heading and provides a solution quality factor.

Therefore, using the electronic positioning system 130, the inventive system 100 may effectively and accurately make deliveries, for example, in low-visibility conditions. For instance, the inventive system 100 may be used to make nighttime deliveries or deliveries in adverse weather conditions (e.g., fog or a hard rain or snow). Ordinarily, a driver would not be able to make deliveries in such conditions because the street signs and address numbers are not visible to the driver of the transport vehicle. With the inventive system 100, however, the driver does not need to visibly see an address or street sign because the electronic positioning system 130 informs the driver when the transport vehicle 110 has arrived at the destination address. Therefore, the inventive system 130 results in packages getting to a destination faster than conventional delivery systems.

More particularly, the positioning system 130 may include a video display which the driver of the transport vehicle 110 may use to find a position of the transport vehicle or a destination. Further, the positioning system 130 may include an audible alarm or light-emitting signal for notifying the driver when a destination is reached. Further, some features, such as the user receiver and video display of the positioning system 130 may be integrated with the computer system 15 onboard the transport vehicle 110 to form a compact space-efficient console having these helpful features.

Referring back to FIG. 1, the inventive delivery system 100, may further include a base station 150. The transport vehicle may include a transceiver which wirelessly communicates with a base station 150 to optimize a delivery route. In addition, the transport vehicle 110 may include a loop antenna to facilitate a two way communication with the base station 150.

The inventive system 100 may further include containers 200 (e.g., bags or totes) which contain packages to be delivered to a destination. As shown in more detail in FIG. 2, the containers 200 may be made from materials such as canvas or nylon, and may include a support device 205 (e.g., a support strap) attached to the container 200 (e.g. at the top of the container) for transporting the container 200.

In the inventive system 100, the container 200 may be loaded with packages, for example, at a distribution center. The packages may then be transferred onto the transport vehicle 110 where the packages are sorted, for example, on shelves in the transport vehicle 110, with each package having a specific location (e.g., a predetermined location) on the transport vehicle. Further, the location of a package (e.g., location code) may determined so as to minimize driver time. For example, the location may be determined based upon, for example, the route the transport vehicle 110 must take to deliver all the packages. For example, the packages can be placed from left to right, front to back, upper to lower or lower to upper or in any other order, according to such factors as the destination of the package or the anticipated time of delivery. For example, the earliest or closest deliveries may start on the lower left side of the transport vehicle 110 and proceed up and right along the wall of the transport vehicle 110 so that the latest or farthest deliveries would be located on the lower right side of the transport vehicle 110. Therefore, the delivery driver does not have to know what package is to be delivered to a particular destination. Instead, the driver may make a delivery knowing, for example, a package located at a particular location on the transport vehicle 110 is to be delivered to a particular destination.

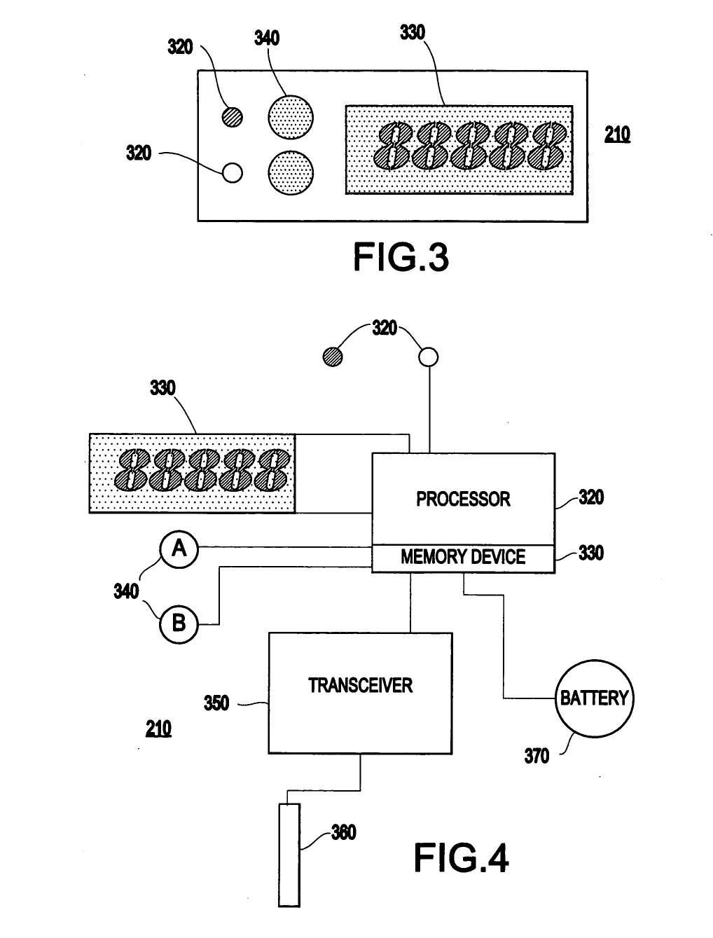

Further, as shown in FIG. 3, the inventive system 100 may further utilize small electronic tags 210 (i.e., display modules). The electronic tag 210 may be located, for example, in a small translucent pocket 220 on the container 200. The tag may include signaling devices such as a red or green light emitting diodes 320, a liquid crystal display 330 (LCD) for alphanumeric display, and switches 340 (e.g., buttons) for controlling the electronic tag 210. The electronic tag 210 may be used, for example, to help direct the placement of packages on the transport vehicle. For example, a package's proper location on the transport vehicle may be displayed on the LCD 330 so that it may be easily viewed, for example, by package handlers at the distribution center.

FIG. 4 provides a more detailed description of the electronic tag 210. As shown in FIG. 4, the electronic tag 210 additionally may include an inexpensive processor 320 (e.g., a low powered four bit microprocessor), a memory device 330 (e.g., a random access memory (RAM)) or other nonvolatile memory device for storing a unique identification number. The identification number may be permanent, so that it can be changed only with a special program and transmitter.

The electronic tag 210 may also contain a transceiver 350 (e.g., a two-way communication chip) for allowing the electronic tag 210 to communicate with the base station 150 or the transport vehicle 110. The two-way communications chip may be, for example, a low-cost CMOS analog digital chip. The two-way communications chip may be connected to orthogonal ferrite antennas 360 that are able to transmit and receive using low frequencies to the loop antenna connected to the base station. Further, the electronic tag 210 may wirelessly communicate with the base station 150 or transport vehicle 110 via a bi-directional wireless link. The wireless link may include, for example, a low frequency conductive loop requiring minimal power and allowing communication within a small area. Further, the LCD 330 may be programmed to display both numeric as well as alphanumeric information transmitted to the module via the base station 150 or transport vehicle 110. The circuitry may be solar powered or powered, for example, by a battery 370 or other power source. Battery life using conventional alkaline batteries is likely to exceed five years, and with AAA batteries the life maybe longer.

In addition, the base station 150 may poll all of the electronic tags 210 in the inventive system 210 in search of a particular electronic tag 210 and in communicate only with that particular tag. Thus, the base station 150 is capable of placing specific information on the display 330, activating/deactivating the signaling device (e.g., flashing the light emitting diodes 320), selectively activating each electronic tag 210 contained in each container 200.

The inventive system 100 may also determine an optimal route for the transport vehicle. An optimal route may be used, for example, to minimize time or distances traveled by the transport vehicle. The optimal route may be determined, for example, using the electronic positioning system 130 and the coordinates or addresses of each package's destination. The optimal route may be, for example, input into the computer system 115 located on the transport vehicle 110. The ID numbers of the electronic tags 210 can also be loaded into the computer system 115. The electronic positioning system 115 can also be used to guide the transport vehicle to a package's destination via a map, or other conventional routing software. When the transport vehicle 110 arrives at a package destination, the computer system 115 can alert the driver, for example, audibly or by displaying a text message on the display of the computer system 115. The message to the driver may include, for example, the destination address, the number of packages to be delivered, and the package's location on the transport vehicle. In addition, the computer system 115 may cause the electronic tag 210, for example, on the container 200 in which the package is located, to be activated so as to facilitate locating the package by the driver. For example, the signaling devices (e.g., light emitting diodes) on the electronic tag 210 may be activated so that the driver can easily locate the package. The driver need only locate signal (e.g., a flashing light), remove the package from the container 200 and deliver it to its destination. The driver may also activate the switch 340 (e.g., a button) on the electronic tag 210 to indicate that the package has been properly delivered to its destination. In addition, if for some reason the package could not be delivered, the driver may place the package back into the container and use switches to indicate that delivery was attempted but unsuccessful.

Further, additional information can be displayed on the LCD 330 of the electronic tag 210 at different times. For example, after the container 200 is loaded on the transport vehicle 110, the number of packages contained in the container 200 can be displayed so the driver can periodically check the contents of each container 200.

Furthermore, when the container 200 is empty, the driver may deactivate the electronic tag 210 using an activation switch 340 (e.g., a button) on the electronic tag 210. The electronic tag 210 may also be automatically deactivated, for example, by placing the container 200 and/or the electronic tag 210 at a particular location on the transport vehicle. In addition, the computer system 115 wirelessly communicates with the electronic tag and may, therefore, detect that the container 200 is no longer in use.

The container 200 used by the inventive system 100 may include, for example, a tote. In this case, the electronic tag may be located, for example, on the front of the tote. In addition, a simple, inexpensive electronic tag may contain a single LED to facilitate locating the package by the delivery driver.

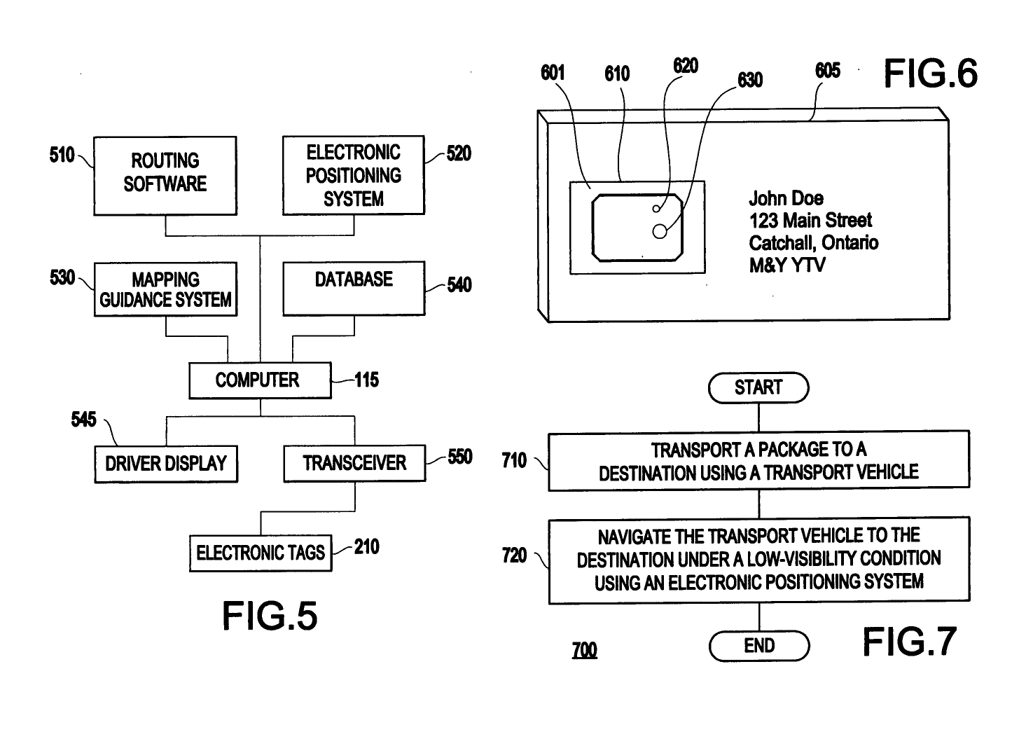

Further, the inventive system 100 includes several hardware and software components. The electronic positioning system 130 provides coordinates of the address is where items are to be delivered and as shown in FIG. 5, routing software 510 may be used to calculate an optimal route based on those coordinates. The electronic positioning system 520, may detect the location of a transport vehicle 110 in real-time. A mapping guidance system 530 may also be used to direct the driver to the correct address. A database 540 holding the correct container and the ID for the tag attached to the container plus the electronic positioning system address is also stored on the computer 115. The computer 115 may include, for example, a display 545 (e.g., a laptop computer with a flat-panel display) which is temporarily located near the delivery driver in the transport vehicle. The computer 115 may also include a transceiver 550 connected to the loop antenna 140 for wirelessly communicating with the base station 150 and electronic tag 210. The base station 150 similarly may include a transceiver allowing it to wirelessly communicate with all of the electronic tags 210 in the inventive system 100 by the unique ID number of the tags. Thus, the inventive system 100 can activate a signaling device (e.g., an LED) on a particular container 200 or package when the delivery driver arrives at the destination for that particular package.

Further, as shown in FIG. 6, a small electronic tag 601 may be placed, for example, not on the container 200 but instead, directly on the package 605. In this case, the driver may remove the tag 601 as the package is delivered to its destination, and place the tag in a special bin located, for example, in the transport vehicle. Further, the electronic tag 601 may be placed on the package using an adhesive pouch 610 having a plastic window. Tag 601 might be very flat like a credit card with only a single lightning diode 620, and a small switch 630 (e.g., button) and in all other respects is the same as the electronic tag 210 in FIGS. 3 and 4.

Further, the inventive system 100 may include a drop box 140 which is located at the package destination for receiving the package. The drop box 140 also contains a transceiver for wirelessly communicating with the electronic tag 210 as well as the transport vehicle 110 and the base station 150.

For example, the electronic tag 210 may be used to be used as an access card to open the electronic drop box at the package's destination. For example, the driver may activate the switch (e.g, push a button) on the tag 210 to gain access to the drop box 140. The transceiver on the tag 210 can wirelessly communicate with the drop box 140 causing the drop box 140 to open. For instance, where the tag 210 is affixed to the package, after the package is placed in the drop box 140, the tag 210 may be removed and placed in a bin located, for example, on the transport vehicle 110. In addition, the driver may deactivate the tag 210 to indicate that the tag 210 is no longer in use and/or that the package was properly delivered, using the switch on the electronic tag 210. Further, the tag 210 may include a memory which records, for example, the date and time that the tag was used to open the drop box 140.

The claimed invention also includes an inventive method 700 for delivering a package (e.g., packages). As shown in FIG. 7, the inventive method 700 includes transporting 710 the package to a destination. For example, the transport vehicle may include a first transceiver and a computer system. The inventive method also includes navigating 720 the transport vehicle to the destination under a low-visibility condition.

Further, the inventive method 700 may include associating the packages with electronic tags. As noted above, several packages may be placed in one container having an electronic tag 210 or a package may have an electronic tag 210 affixed thereto. Further, the inventive method 700 may include inputting a destination address to a computer system to determine an optimum delivery route. As mentioned above, the computer system may be located on the transport vehicle 110 and have a display panel which the drive may use to easily locate a destination and determine the position of the transport vehicle 110. Alternatively, the computer system may be located, for example, at a distribution center. In this case the computer system would determine an optimum route and wirelessly transmit the route to the transport vehicle. In addition, the inventive method may include placing the packages on the transport vehicle 110. As mentioned above the electronic positioning system may include a gyroscope, a satellite-based global positioning system (GPS), a dead reckoning (DR) system, or a hybrid system containing the features of such positioning devices. The electronic positioning system may aid in the delivery of packages in low-visibility conditions, such as nighttime and in adverse conditions such as adverse weather conditions.

With its unique and novel aspects, the present invention provides a system and method for effectively and accurately delivering a package in adverse conditions.

While a preferred embodiment of the present invention has been described above, it should be understood that it has been provided as an example only. Thus, those skilled in the art will recognize that the invention can be practiced with modification within the spirit and scope of the appended claims.

1. A system for delivering a package, comprising
a transport vehicle for transporting said package to a destination, said transport vehicle comprising a first transceiver and a computer system; and
an electronic positioning system for navigating said transport vehicle to said destination under a low-visibility condition.

2. The system according to claim 1, further comprising:
a drop-box comprising a second transceiver for wirelessly communicating with said first transceiver, and a signaling device for locating said drop-box under a low-visibility condition.

3. The system according to claim 2, wherein during a low visibility condition, said first transciever wirelessly communicates with the said second transceiver, causing said drop-box to activate said signaling device.

4. The system according to claim 3, wherein said signaling device is activated when said transport vehicle is within a predetermined distance of said drop-box.

5. The system according to claim 1, further comprising:
an electronic tag associated with said package, said electronic tag comprising:
a signaling device which activates when said transport vehicle is within a predetermined distance of said destination; and
a third transceiver, for wirelessly communicating with said first and second transceivers.

6. The system according to claim 1, wherein a low-visibility condition comprises at least one of a nighttime condition and an adverse weather condition.

7. The system according to claim 2, wherein said low-visibility condition comprises a condition under which said drop-box is obscured from a view of a person delivering said package.

8. The system according to claim 1, further comprising:
a detecting device for detecting a low-visibility condition.

9. The system according to claim 8, wherein said detecting device comprises a photodiode.

10. The system according to claim 2, wherein said signaling device is manually activated using said computer system to regulate a signal transmitted from said first transceiver to said second transceiver.

11. The system according to claim 2, wherein a magnitude of a signal emitted by said signaling device is regulated by using said computer system to regulate a signal transmitted from said first transceiver to said second transceiver.

12. The system according to claim 2, wherein said computer system comprises a locator database for storing detailed location data for said drop-box.

13. The system according to claim 12, wherein data from said electronic positioning system is refined using said detailed location data.

14. A system for delivering packages, comprising:
a transport vehicle comprising:
a first transceiver; and
a computer system;
an electronic tag associated with at least one of said packages, comprising:
a signaling device which activates when a package arrives at a destination; and
a second transceiver, for wirelessly communicating with said transport vehicle; and
an electronic positioning system for navigating said transport vehicle to said destination according to an optimum delivery route.

15. The system according to claim 14, wherein said electronic positioning system comprises a satellite-based global positioning system (GPS) comprising:
at least one satellite for wirelessly transmitting signals;
a ground based control station for uploading data to and receiving signals from said at least one satellite; and
a user receiver located on said transport vehicle for receiving signals from said at least one satellite.

16. The system according to claim 14, wherein said electronic positioning system comprises a dead reckoning (DR) system which measures compass direction and a speed of said transport vehicle.

17. The system according to claim 16, wherein said electronic positioning system comprises a solid state gyroscope.

18. The system according to claim 15, wherein said global positioning system further comprises:
a reference station which compares predicted pseudoranges to actually measured pseudoranges, computes correction data for each said satellite and broadcasts said correction data over a separate data link to said user receiver,
wherein said user receiver applies said correction data to a pseudorange measurement to compute a position.

19. The system according to claim 15, wherein said electronic positioning system further comprises a dead reckoning (DR) system which measures compass direction and a speed of said transport vehicle, and
wherein said dead reckoning system is used to augment said satellite-based global positioning system.

20. The system according to claim 14, further comprising:
a base station comprising a third transceiver for wirelessly communicating with said transport vehicle and said electronic tag.

21. The system according to claim 20, further comprising:
a drop-box located at said destination, comprising a fourth transceiver for wirelessly communicating with said transport vehicle, said electronic tag and said base station.

22. The system according to claim 14, wherein said signaling device is activated when said package arrives at said destination, and wherein said first and second transceivers wirelessly communicate with each other to minimize a delivery time.

23. A system for low-visibility package delivery, comprising:
a transport vehicle comprising:
a first transceiver; and
a computer system; and
an electronic positioning system for navigating said transport vehicle to said destination according to an optimum delivery route,
wherein a low-visibility condition causes a location of said destination to be hardly visible to a person making a delivery.

24. The system according to claim 23, wherein said low-visibility condition comprises one of an adverse weather condition and a nighttime condition.

25. The system according to claim 23, further comprising:
a drop-box located at said destination for receiving a package,
wherein a low-visibility condition causes a drop-box located at said destination to be hardly visible to a person making a delivery.

26. A method for delivering packages, comprising:
transporting said package to a destination using a transport vehicle; and
navigating said transport vehicle to said destination under a low-visibility condition, using an electronic positioning system.

27. A method for delivering packages, comprising:
associating said packages with electronic tags;
inputting a destination address to a computer system to determine an optimum delivery route;
placing said packages on a transport vehicle; and
navigating said transport vehicle to a destination using an electronic positioning system.

28. The method according to claim 27, further comprising:
activating a signaling device on a particular electronic tag when said transport vehicle arrives at a destination of a package associated with said particular electronic tag.

29. The method according to claim 27, wherein said electronic tag is temporarily affixed to one of said container and said package.

30. The method according to claim 27, wherein said packages are temporarily stored in a container and said electronic tag is affixed to said container.

31. A programmable storage medium tangibly embodying a program of machine-readable instructions executable by a digital processing apparatus to perform a method for delivering packages, said method comprising:
transporting said package to a destination using a transport vehicle; and
navigating said transport vehicle to said destination under a low-visibility condition, using an electronic positioning system.
